(19) United States
(12) Patent Application Publication
(10) Pub. No.: US 2026/0310689 A1
(43) Pub. Date: Oct. 8, 2026

(54) PROCESSING QUERIES USING EXPLICITLY DEFINED RELATIONSHIPS AND INFERRED RELATIONSHIPS OF DATA OBJECTS

(71) Applicant: Dell Products L.P., Round Rock, TX (US)

(72) Inventors: XIAOCHEN CHEN, Shanghai (CN); ZIJIA WANG, London (GB); SCOTT E. JOYCE, Foxboro, MA (US); NING LI, Shanghai (CN)

(21) Appl. No.: 19/098,578

(22) Filed: Apr. 2, 2025

(51) Int. Cl. G06F 16/28; G06F 16/242

(52) U.S. Cl. CPC G06F 16/288; G06F 16/2423

(57) ABSTRACT

Methods and systems for managing use of data sources of a distributed system are disclosed. The use of the data sources may be managed by processing queries using a refined dependency graph. The refined dependency graph may include nodes, based on data objects in the data sources, and/or edges, based on explicitly defined relationships and/or inferred relationships. The explicitly defined relationships may be based on database keys (e.g., primary keys, foreign keys, key constraints, and/or any other database key). The inferred relationships may be based on any measures of semantic similarity of the data objects. The any measures of the semantic similarity may be computed using a trained machine learning model.

### FIELD

Embodiments disclosed herein relate generally to manage use of data sources of a distributed system. More particularly, embodiments disclosed herein relate to processing queries using explicitly defined relationships and inferred relationships of data objects in the data sources.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a distributed system in accordance with an embodiment.

FIGS. 2A-2C show data flow diagrams illustrating operation of a distributed system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing use of data sources of a distributed system. The use of the data sources may be managed by processing queries using explicitly defined relationships and/or inferred relationships of data objects in the data sources.

To process the queries, a data operation request may first be obtained. The data operation request may include a request to perform at least one operation on data of a data repository (e.g., a database and/or any other data repository). The at least one operation may include (i) filtering, (ii) joining, (iii) aggregating, (iv) grouping, (v) updating, (vi) deleting, (vii) transforming, (viii) sorting, (ix) constraining, and/or (x) any other operation.

To process the queries, a template, based on the data operation request, may be identified. The template may be identified by at least performing a structure analysis, by the distributed system, of the data processing request. The structure analysis may include at least identifying the at least one operation requested by the data operation request. The template may include placeholders that can be populated.

The template, including the placeholders, may be populated by using a refined dependency graph to obtain a processable query. The refined dependency graph may include (i) a plurality of nodes based on data objects in the data sources, (ii) a first plurality of edges between the nodes, the first plurality of the edges being based on explicitly defined relationships between the data objects, and (iii) a second plurality of the edges between the nodes, the second plurality of the edges being based on inferred relationships between the data objects.

The explicitly defined relationships may be based on (i) primary keys (e.g., identifiers for table rows), (ii) foreign keys (e.g., links for rows between a first table and/or a second table), (iii) key constraints (e.g., rules that enforce integrity of the data by limiting a type, format, and/or range of the data that can be stored in a table of a data object), etc. between the data objects. The inferred relationships may be based on any magnitudes of semantic similarity between the data objects. The any magnitudes of semantic similarity may be computed using a trained machine learning model (e.g., Bidirectional Encoder Representations from Transformers (BERTs), word embedding models (e.g., Word2Vec, GloVe, FastText, and/or any other word embedding model), recurrent neural networks, and/or any other trained machine learning model).

Finally, the processable query of the queries may be processed. The processable query may be processed using a query service engine. As a result, the data operation request may be serviced.

As the processable query includes identifiers based on the explicitly defined relationships and/or the inferred relationships of the data objects, desired computer implemented services may be provided by processing of the processable query by the query servicing engine.

In an embodiment, a method for managing use of data sources of a distributed system is disclosed. The method may include: (i) obtaining a data operation request, (ii) identifying a template based on the data operation request, (iii) populating the template using a refined dependency graph to obtain a processable query, the refined dependency graph including: (a) a plurality of nodes based on data objects in the data sources, (b) a first plurality of edges between the nodes, the first plurality of the edges being based on explicitly defined relationships between the data objects, and (c) a second plurality of the edges between the nodes, the second plurality of the edges being based on inferred relationships between the data objects, and (iv) processing the processable query using a query servicing entity to service the data operation request.

The data operation request may include a database request.

The explicitly defined relationships may be obtained from a schema of a data source of the data sources.

The inferred relationships may be based on relationships between the data objects, the relationships being based on embeddings derived from the data objects and machine learning model analysis.

The relationships may be based on semantic similarities between the embeddings.

The inferred relationships may be based, at least in part, on semantic similarities between the embeddings.

The template may not be processable by a query servicing engine due to presence of unpopulated placeholders in the template.

Populating the template using the refined dependency graph to obtain the processable query include: (i) filtering the data objects, based on the data operation request, the first plurality of the edges and the second plurality of the edges, to identify at least one of the data objects, and (ii) adding at least one identifier for the at least one of the data objects to the template to generate the processable query.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

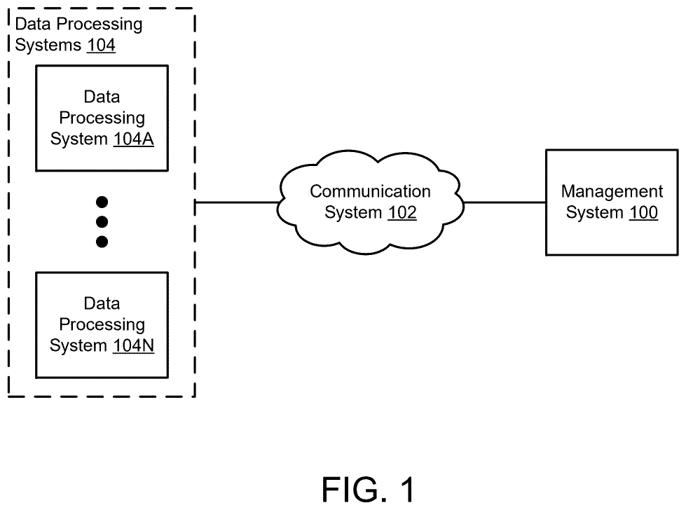

Turning to FIG. 1, a distributed system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a processable query may be transmitted to a query servicing entity of the distributed system to service a data operation request. The data operation request may include a request by (i) a user, (ii) an application, and/or (iii) any other entity to perform at least one operation on at least a portion of data in a data repository of the distributed system. The processable query may include (i) a query template (e.g., a schema for outlining a pre-defined structure of a query with placeholders for identifiers of the query), (ii) identifiers (e.g., values, based on explicitly defined relationships of the data from data objects of a database schema, that are set in the placeholders of the query template to generate the processable query), (iii) query metadata (e.g., query identification, timestamp, user credentials, permission levels, etc.), etc. The query servicing entity may include (i) database management systems (e.g., MySQL, PostgreSQL, Oracle Database, etc.), (ii) distributed database systems (e.g., Amazon Aurora, Google Cloud Spanner, Apache Cassandra, etc.), (iii) query engines (e.g., Apache Hive, Presto, Amazon Athena, etc.), etc.

The query servicing engine may process the processable query by (i) ingesting, by the query servicing engine, the processable query, (ii) obtaining, by the query servicing engine and/or based on the processable query, retrieved data from at least one data repository of the distributed system, and/or (iii) performing at least one operation (e.g., filtering, joining, aggregating, grouping, updating, deleting, transforming, sorting, constraining, and/or any other operation), according to contents of the pre-defined structure using the retrieved data.

However, because the processable query relies on explicitly defined relationships of the data, the servicing of the data operation request may be impacted. The servicing of the data operation request may be impacted because (i) the data is based on the explicitly defined relationships and/or does not include other data based on non-explicit (e.g., complex, indirect, etc.) relationships and/or (ii) a dependence on the explicitly defined relationships can include multiple joins clauses, which can inhibit a performance by the query servicing engine.

In general, embodiments disclosed here relate to systems and methods for managing use of data sources of a distributed system. The use of the data sources may be managed by (i) obtaining a data operation request, (ii) identifying a template based on the data operation request, (iii) populating the template using a refined dependency graph to obtain a processable query, the refined dependency graph comprising (a) a plurality of nodes based on data objects, (b) a first plurality of edges between the nodes, the first plurality of the edges being based on explicitly defined relationships between the data objects, and/or (c) a second plurality of the edges between the nodes, the second plurality of the edges being based on inferred relationships between the data objects, and/or (iv) processing the processable query using a query servicing entity to service the data operation request.

The data operation request may be obtained by (i) transmitting, by a user, an application, and/or any other entity, the data operation request through a front-end interface and/or an application user interface (API), (ii) generating, by an automated system, the data operation request, (iii) managing, by a workflow engine, the data operation request in a data pipeline, etc. The data operation request may include a request to perform at least one operation on at least a portion of data in a data repository of the distributed system. The at least one operation may include filtering, joining, aggregating, grouping, updating, deleting, transforming, sorting, constraining, etc. on the at least the portion of the data of the data objects.

The template, based on the data operation request, may be identified by (i) performing a structure analysis, by the distributed system, of the data processing request and/or (ii) matching the template to the data operation request. The structure analysis may include (i) identifying the at least one operation requested by the data operation request and/or (ii) identifying components of the data operation request including (a) data object names, (b) column names, (c) value types, (d) conditions, (e) join requirements, and/or (f) any other components. The template may be matched by (i) performing a search for the template that includes (a) the at least one operation and/or (b) the components of the data operation request.

The template may be populated using the refined dependency graph to obtain a processable query. The template may be populated by (i) ingesting, by the distributed system, the refined dependency graph, (ii) identifying nodes, based on the data operation request, of the plurality of the nodes, (iii) identifying the explicitly defined relationships and/or the inferred relationships between the nodes, and/or (iv) populating the template with identifiers of the first data of the explicitly defined relationships and/or second data of the inferred relationships.

The dependency graph may be ingested by reading, by the distributed system, the dependency graph. The nodes may be identified by determining, the distributed system, which of the nodes (and therefore which data objects) may be associated with the data operation request. The explicitly defined relationships and/or the inferred relationships may be identified by traversing at least one edge of the first plurality of the edges and/or the second plurality of the edges, starting from one node of the nodes to a second node connected by the at least one edge. As a result, a first explicitly defined relationship and/or a first inferred relationship may be identified between the first node (and therefore a first data object) and/or the second node (and therefore a second data object). The template may be populated by setting identifiers (e.g., column names, keys, indices, any other identifier of a data object) of the first data and/or the second data to generate the processable query.

The processable query may be processed using the query servicing entity to service the data operation request. The processable query may be processed by (i) ingesting, by the query servicing engine, the processable query, (ii) obtaining, by the query servicing engine and based on the processable query, retrieved data from at least one data repository (e.g., database) on at least one data processing system of the distributed system, and/or (iii) performing the at least one operation requested by the data operation request using the retrieved data.

As the processable query includes identifiers of the data objects, which includes the explicitly defined relationships and/or the inferred relationships, desired computer implemented services may be provided by the distributed system. The desired computer implemented services may be provided because the distributed system may (i) retrieve, (ii) integrate, and/or (iii) manipulate the relevant data to provide (i) accurate, (ii) insightful, and/or (iii) optimized computer implemented services.

To provide the above noted functionality, the system may include management system 100 and/or data processing systems 104. Each of these components is discussed below.

Data processing systems 104 may include any number of data processing systems (e.g., 104A-104N). The any number of the data processing systems (e.g., 104A-104N) may include client devices of (i) users, (ii) administrators, and/or (iii) any other stakeholder of the distributed system. The any number of the data processing systems (e.g., 104A-104N) may include any number of (i) hardware, (ii) software, and/or (iii) data repositories (e.g., databases). The software may include trained machine learning models (e.g., Bidirectional Encoder Representations from Transformers (BERTs), word embedding models (e.g., Word2Vec, GloVe, FastText, and/or any other word embedding model), recurrent neural networks, and/or any other trained machine learning model.).

The data repositories may include any number of (i) relational databases, (ii) distributed databases, (iii) any type and/or number of databases of the distributed system, (iv) search engines, and/or (v) any other type of data repository. The software may include query servicing engines. The query servicing engines may include (i) database management systems (e.g., MySQL, PostgreSQL, Oracle Database, etc.), (ii) distributed database systems (e.g., Amazon Aurora, Google Cloud Spanner, Apache Cassandra, etc.), (iii) query engines (e.g., Apache Hive, Presto, Amazon Athena, etc.), etc. The data repositories may be used to store (i) query templates, (ii) structured data (e.g., tables with rows and/or columns), (iii) unstructured data (e.g., text documents), (iv) semi-structured data (e.g., data with tags and/or metadata), (v) graph data (e.g., data with nodes and/or edges), (vi) any other data.

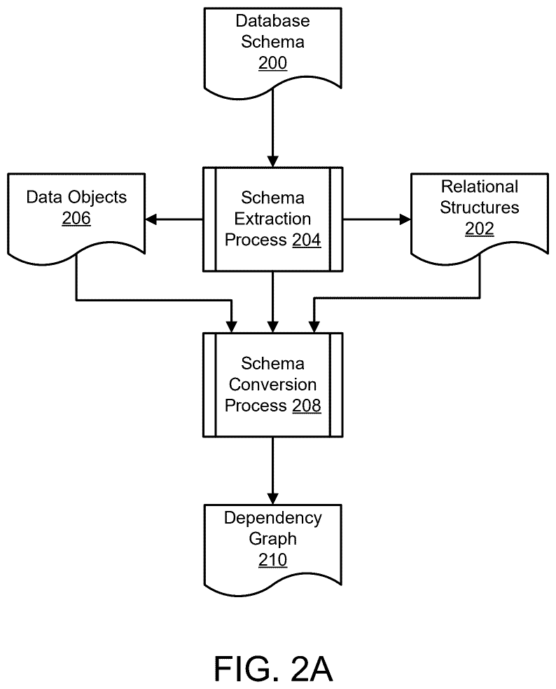

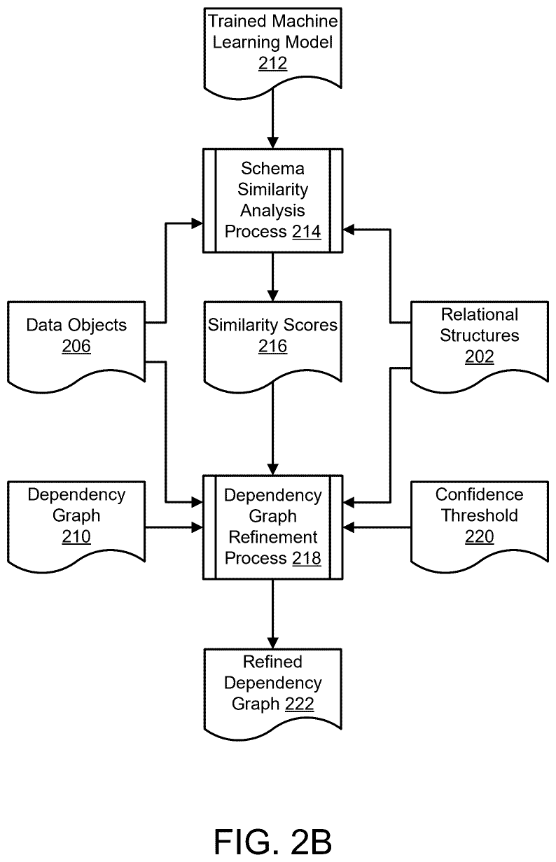

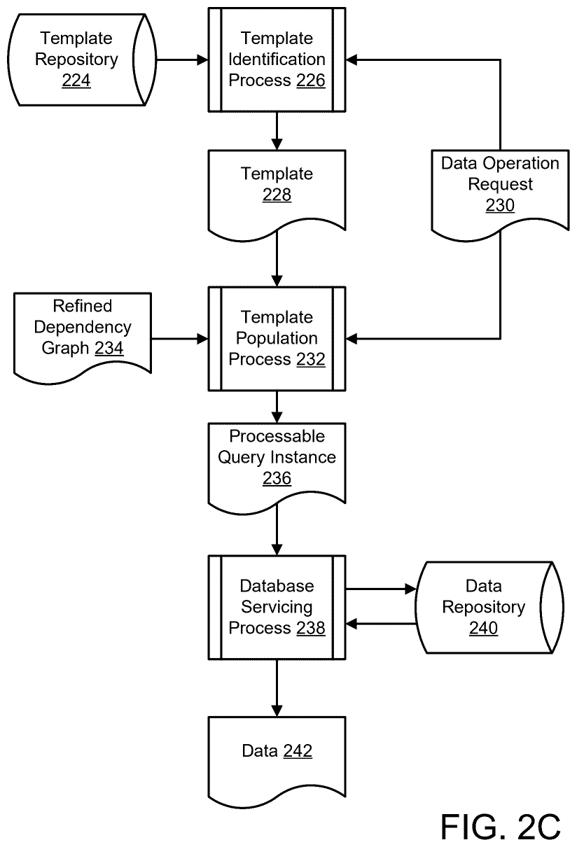

Management system 100 may generate a dependency graph of at least one database of the distributed system. Management system 100 may generate the dependency graph by assigning the any number of the data processing systems (e.g., 104A-104N) to (a) extract data objects and/or relational structures (e.g., keys, constraints, indexes, and/or any other relational structure) from a database schema and (b) generate, using the data objects and/or the relational structures, the dependency graph. Generation of the dependency graph is described in the description of FIG. 2A.

Further, management system 100 may generate a refined dependency graph by assigning the any number of the data processing systems (e.g., 104A-104N) to (i) perform, using the data objects, the relational structures, and/or a trained machine learning model of the trained machine learning models, a similarity analysis to generate similarity scores, and/or (ii) generate, using the similarity scores, the dependency graph, and a confidence threshold, the refined dependency graph. Generation of the refined dependency graph is described in the description of FIG. 2B. The refined dependency graph may be stored in any database of the databases on the any number of the data processing systems (e.g., 104A-104N).

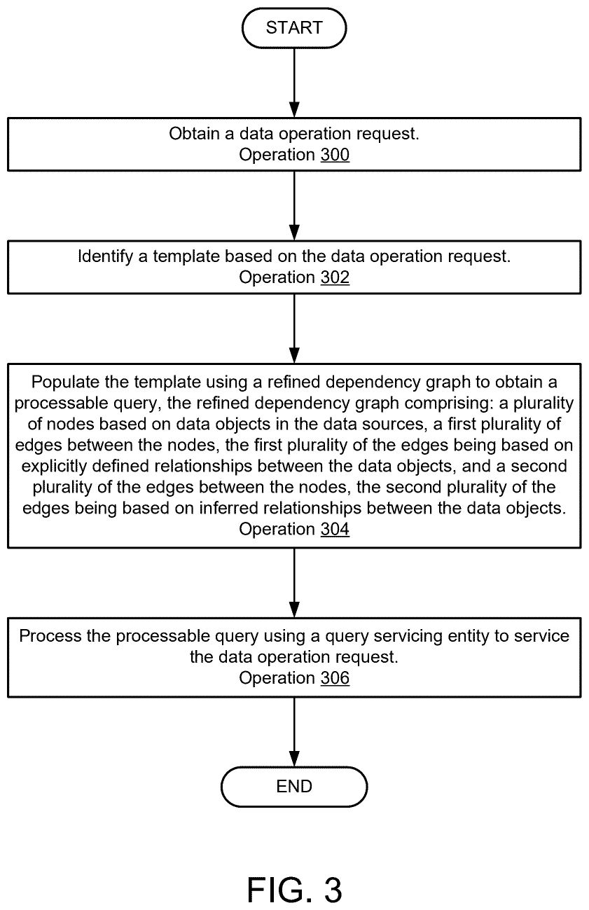

While providing their functionality, any of management system 100 and/or data processing systems 104 may perform all, or a portion, of the flows and methods shown in FIGS. 2A-3.

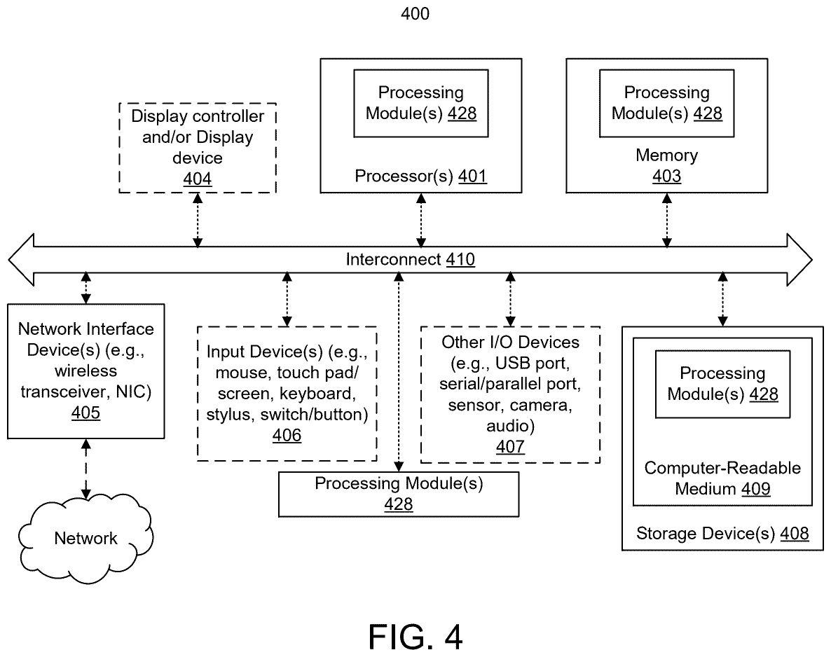

Any of (and/or components thereof) management system 100 and data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 202, etc.) is used to represent data structures, a second set of shapes (e.g., 204, 208, etc.) is used to represent processes performed using and/or that generate data, and a third set of shapes (e.g., 224, 240, etc.) is used to represent large scale data structures such as databases.

Turning to FIG. 2A, a first data flow diagram in accordance with an embodiment is shown. The first data flow diagram may illustrate data used in and data processing performed in generating a dependency graph.

To generate the first dependency graph, a schema extraction process (e.g., 204) may be performed. During the schema extraction process (e.g., 204), a database schema (e.g., 200) may be ingested. Before the ingestion, the database schema (e.g., 200) may be obtained by (i) performing a first search for the database schema (e.g., 200) of a database and/or (ii) outputting the database schema (e.g., 200) from the database. The first search may be performed using a database management tool (e.g., MySQL, Oracle, PostgreSQL, and/or any other database management tool). The database schema (e.g., 200) may be output, for example, in a first data structure that uses a data format such as and/or not limited to an extensible markup language (XML) data format, JavaScript Object Notation (JSON) data format, a comma-separated value (CSV) file, a data definition language (DDL) data format, etc.

The database schema (e.g., 200) may include data objects (e.g., 206) and/or relational structures (e.g., 202). The data objects (e.g., 206) may include data structures (e.g., tables, indices, views, sequences, stored procedures, and/or any other data structure) that store data. The relational structures (e.g., 202) may include (i) primary keys (e.g., identifiers for table rows), (ii) foreign keys (e.g., links for rows between a first table and/or a second table), (iii) key constraints (e.g., rules that enforce integrity of the data by limiting a type, format, and/or range of the data that can be stored in a table of a data object), etc. between the data objects (e.g., 206). The relational structures (e.g., 202) may further include list of identifications of the data objects. Also (i) the primary keys, (ii) the foreign keys, (iii) the key constraints, and/or (iv) any other relational structure may establish explicitly defined relationships between the data objects.

During the schema extraction process (e.g., 204), after the ingestion on the database schema (e.g., 200), the database schema (e.g., 200) may be analyzed to identify the data objects (e.g., 206) and/or the relational structures (e.g., 202). The database schema (e.g., 200) may be analyzed by parsing the database schema (e.g., 200) for the data objects (e.g., 206) and/or the relational structures (e.g., 202) using a parsing application for a data format of the database schema (e.g., 200). The parsing application may be used to output the data objects (e.g., 206) in a second data structure and/or the relational structures (e.g., 202) in a third data structure. The data format of the second data structure and/or the third data structure may include XML, JSON, CSV, DDL, etc.

Once the data objects (e.g., 206) and/or the relational structures (e.g., 202) have been obtained, a schema conversion process (e.g., 208) may be performed. During the schema conversion process (e.g., 208), a dependency graph (e.g., 210) may be generated using the data objects (e.g., 206) and/or the relational structures (e.g., 202). The dependency graph (e.g., 210) may be generated by (i) ingesting the data objects (e.g., 206) and/or the relational structures (e.g., 202), (ii) generating an empty dependency graph that does not include nodes and/or edges, and/or (iii) adding the nodes based on the data objects (e.g., 206) and/or (iv) adding the edges based on the relational structures (e.g., 202) to the empty dependency graph to generate the dependency graph (e.g., 210).

To, for example, add a node to the empty dependency graph, a table of the node and/or a set of attributes (table names, column names, data types, indices, and/or any other attribute) of a data object may be added to the node. The node then may be added to the empty dependency graph to generate a node graph.

To, for example, add an edge to the node graph, a relational structure may be selected from the relational structures (e.g., 202). The relational structure may include the identifications of at least two data objects and/or an explicitly defined relationship based on (a) the primary keys, (b) the foreign keys, (c) the key constraints, and/or (d) any other explicitly defined relationship between the at least two data objects. A second search may be performed on the node graph for two nodes that include the identifications of the at least two data objects. Once the two nodes are found in the second search, the edge may be added between the two nodes to generate the dependency graph (e.g., 210).

The dependency graph (e.g., 210) may include (a) a plurality of nodes based on data objects (e.g., 206) in the data sources and/or (b) a first plurality of edges between the nodes, the first plurality of the edges being based on explicitly defined relationships of the relational structures (e.g., 202). The node of plurality of the nodes may include the table of the data object and/or the set of the attributes (table names, column names, data types, indices, and/or any other attribute) of the data object of the data objects (e.g., 206). The edge of the first plurality of the edges may be connected to the two nodes. The edge may be connected to the two nodes because two data objects, the attributes of which being included in the two nodes, may have the explicitly defined relationship.

Thus, via the first data flow diagram illustrated in FIG. 2A, a system in accordance with an embodiment may generate the dependency graph (e.g., 210). Consequently, the distributed system may be more likely to be able to provide desired computer implemented services by enhancing, using the dependency graph (e.g., 210), an efficiency of processing of a processable query by a query servicing engine.

Turning to FIG. 2B, a second data flow diagram in accordance with an embodiment is shown. The second data flow diagram may illustrate data used in and data processing performed in generating a refined dependency graph.

To generate the refined dependency graph (e.g., 222), a schema similarity analysis (e.g., 214) may be performed. During the schema similarity analysis (e.g., 214), data objects (e.g., 206), relational structures (e.g., 202), and/or a trained machine learning model (e.g., 212) may be ingested. The data objects (e.g., 206) and/or the relational structures (e.g., 202) are described in the description of FIG. 2A.

The trained machine learning model (e.g., 212) may include Bidirectional Encoder Representations from Transformers (BERTs), word embeddings (e.g., Word2Vec, GloVe, FastText, and/or any other word embedding), recurrent neural networks, etc. The trained machine learning model (e.g., 212) may be trained to identify semantic similarities between one or more text strings. Training of the trained machine learning model (e.g., 212) may include (i) supervised learning, (ii) unsupervised learning, (iii) semi-supervised learning, (iv) self-supervised learning, etc.

After the data objects (e.g., 206), the relational structures (e.g., 202), and/or the trained machine learning model (e.g., 212) are ingested, during the schema similarity analysis (e.g., 214), semantic similarity analyses may be performed to generate similarity scores (e.g., 216). To perform the semantic similarity analyses, the trained machine learning model (e.g., 212) may (i) ingest the data objects (e.g., 206) and/or the relational structures (e.g., 202), (ii) convert the data objects (e.g., 206) and/or the relational structures (e.g., 202) into numerical representations (e.g., embeddings and/or other vectorized formats) and/or (iii) generate, using the numerical representations, the similarity scores (e.g., 216). The trained machine learning model (e.g., 212) may generate the similarity scores (e.g., 216) by performing similarity computations (e.g., cosine similarity, Euclidean distance, Jaccard similarity. Manhattan distance, Minkowski Distance, and/or any other distance computation). The similarity scores (e.g., 216) may be computed using different combinations of the numerical representations to generate inferred relationships (e.g., not explicitly defined relationships on which the first plurality of the edges (from FIG. 2A) of the dependency graph (e.g., 210) are based) between the data objects (e.g., 206).

The similarity scores (e.g., 216) may include different ranges based on the similarity computations. In a first example, a cosine similarity score includes a single integer bounded and/or including 0.0 and/or 1.0. The cosine similarity score further includes a measure of an angle between two vectors of the numerical representations. A first score of 1.0 includes perfect similarity between the two vectors and/or a second score of 0.0 includes no similarity between the two vectors. In a second example, a Euclidean distance also includes the single integer bounded and/or including 0.0 and/or infinity. The Euclidean distance further includes a straight line distance between two points in multi-dimensional space. The two points may be obtained from the two vectors of the numerical representations. A low value for the Euclidean distance may include high similarity between the two vectors and/or a high value for the Euclidean distance may include low similarity between the two vectors.

Once the similarity scores (e.g., 216) have been computed, a dependency graph refinement process (e.g., 218) may be performed. During the dependency graph refinement process (e.g., 218), the dependency graph (e.g., 210), the similarity scores (e.g., 216), and/or a confidence threshold (e.g., 220) may be ingested. The dependency graph (e.g., 210) was described in the description of FIG. 2A.

The confidence threshold (e.g., 220) may include at least one similarity score. The similarity score may match a type, a range, and/or a description of the similarity computations (e.g., cosine similarity, Euclidean distance, Jaccard similarity. Manhattan distance, Minkowski Distance, and/or any other distance computation) performed during the schema similarity analysis process (e.g., 214). The confidence threshold (e.g., 220) may be used as a cutoff value for a similarity score of the similarity scores (e.g., 216) that is computed for at least two numerical representations of the numerical representations. If the similarity score is above and/or below (depending on the type of a similarity computation) the confidence threshold (e.g., 220), then two data objects, associated with the two numerical representations, may be determined to be sufficiently similar.

During the dependency graph refinement process (e.g., 218), comparisons may be performed using the similarity scores (e.g., 216), including the type of the similarity computation used to compute the similarity scores (e.g., 216), and/or the confidence threshold (e.g., 220). The comparisons may be performed by comparing at least one similarity score of the similarity scores (e.g., 216) with the confidence threshold (e.g., 220). Based on the comparisons, (i) the two data objects, associated with the two numerical representations, may be determined to be sufficiently similar and/or (ii) the two data objects, associated with the two numerical representations, may be determined to not be sufficiently similar.

If the two data objects are determined to be sufficiently similar, then an inferred relationship may be established between the two data objects. As a result, an edge may be added to the dependency graph (e.g., 210) and/or connected between two nodes of the two data objects on the dependency graph (e.g., 210) to generate the refined dependency graph (e.g., 222).

If the two data objects are determined to not be sufficiently similar, then at least one action of an action set may be performed: (i) the edge, if already present between the two nodes of the two data objects, may be removed, (ii) a strength, intensity, and/or width of the edge, if already present between the two nodes of the two data objects, may be decreased and/or the edge may not be removed, (iii) a hierarchy of edge types may be established, the edge may be assigned an edge type to indicate insufficient similarity between the two nodes, (iv) the edge may not be removed to allow for any future change in a similarity between the two nodes, (v) any other action that includes not removing the edge to generate the refined dependency graph (e.g., 222)

The refined dependency graph (e.g., 222) may include (a) a plurality of nodes based on data objects in the data sources, (b) a first plurality of edges between the nodes, the first plurality of the edges being based on explicitly defined relationships between the data objects, and/or (c) a second plurality of the edges between the nodes, the second plurality of the edges being based on the inferred relationships between the data objects. The second plurality of the edges may be added to the dependency graph (e.g., 210) during the dependency graph refinement process (e.g., 218) as a result of the comparisons between the similarity scores (e.g., 216) and/or the confidence threshold (e.g., 220) to generate the refined dependency graph (e.g., 222).

At any future time, if an updated dependency graph (e.g., 210) is generated because any modifications to the data objects (e.g., 206) and/or the relational structures (e.g., 202), the schema similarity analysis process (e.g., 214) may be performed again to generate new similarity scores (e.g., 216). The new similarity scores (e.g., 216) and/or the updated dependency graph (e.g., 210) may be ingested by the dependency graph refinement process (e.g., 218) to generate an updated refined dependency graph (e.g., 222).

Thus, via the second data flow diagram illustrated in FIG. 2B, a system in accordance with an embodiment may generate the refined dependency graph (e.g., 222). Consequently, the distributed system may be more likely to be able to provide desired computer implemented services by further enhancing, using the refined dependency graph (e.g., 222), an efficiency of processing of a processable query by a query servicing engine.

Turning to FIG. 2C, a third data flow diagram in accordance with an embodiment is shown. The third data flow diagram may illustrate data used in and data processing performed in using a refined dependency graph (e.g., 234, 222, an updated refined dependency graph, and/or any other refined dependency graph) and/or a processable query instance (e.g., 236) to service a data operation request (e.g. 230).

To service the data operation request (e.g. 230), a template identification process (e.g., 226) may be performed. The template identification process (e.g., 226) may be initiated by obtaining the data operation request (e.g., 230). The data operation request (e.g., 230) may be obtained by (i) transmitting, by a user, an application, and/or any other entity, the data operation request through (a) a front-end interface, (b) an application user interface (API) and/or (b) any other interface, (ii) generating, by an automated system, the data operation request (e.g., 230), (iii) managing, by a workflow engine, the data operation request in a data pipeline, and/or (iv) any other method to obtain the data operation request (e.g., 230). The data operation request may include a request to perform at least one operation on at least a portion of data (e.g., 242) in a data repository (e.g., 240) of the distributed system. The at least one operation may include filtering, joining, aggregating, grouping, updating, deleting, transforming, sorting, constraining, etc. on the at least the portion of the data (e.g., 242).

During the template identification process (e.g., 226), a template (e.g., 228) may be obtained. The template (e.g., 228) may include a schema for outlining a pre-defined structure of a query with placeholders for identifiers of the query. The identifiers may include values and/or data that are (i) based on relationships between data objects (e.g., 206) defined in a database schema (e.g., 200) and/or (ii) set in the placeholders of the template (e.g., 228) to generate the processable query instance (e.g., 236). The template (e.g., 228) may be reusable by allowing the same pre-defined structure to be used to generate the processable query instance (e.g., 236) with different identifiers.

The template (e.g., 228) may be obtained from a template repository (e.g., 224). The template repository (e.g., 224) may be stored on any number of the data processing systems (e.g., 104A-104N) and/or a management system (e.g., 100) of the distributed system. The template (e.g., 228) may be obtained from the template repository (e.g., 224) by (i) performing, based on at least one keyword from and/or any portion of the data operation request (e.g., 230), a keyword search for a purpose, content, structure, category of a use case (e.g., data analysis, marketing, project management, and/or any other use case), and/or metadata (e.g., template name, date of creation, author, popularity, and/or any other metadata tag) of the template (e.g., 228), (ii) identifying, based on at least one search result of the keyword search, at least one template, and/or (iii) extracting one of the at least one template that includes the template (e.g., 228).

Once the template (e.g., 228) has been obtained, a template population process (e.g., 232) may be performed. During the template population process (e.g., 232), the data operation request (e.g., 230), the template (e.g., 228), and/or a refined dependency graph (e.g., 234) may be ingested. The refined dependency graph (e.g., 234) was described in the description of FIG. 2B.

During the template population process (e.g., 232), a processable query instance (e.g., 236) may be generated using the data operation request (e.g., 230), the template (e.g., 228), and/or the refined dependency graph (e.g., 234). The processable query instance (e.g., 236) may be generated by (i) identifying nodes, based on the data operation request, of the plurality of the nodes of the refined dependency graph (e.g., 234), (iii) identifying, using a first plurality of edges (e.g., explicitly defined relationships) between the nodes, first data of relevant data objects of the data objects (e.g., 206), (iv) identifying, using a second plurality of the edges (e.g., inferred relationships) between the nodes, second data of the relevant data objects of the data objects (e.g., 206), and/or (iv) populating the placeholders of the template (e.g., 228) with identifiers (e.g., column names, keys, indices, any other identifier of a data object) from the first data and/or the second data.

The nodes may be identified by determining which of the nodes (and therefore which data objects) include identifiers associated with the data operation request. The explicitly defined relationships and/or the inferred relationships may be identified by traversing at least one edge of the first plurality of the edges and/or the second plurality of the edges, starting from one node of the relevant nodes to a second node connected by the at least one edge. As a result, a first explicitly defined relationship and/or a first inferred relationship may be established between the first node (and therefore a first data object) and/or the second node (and therefore a second data object).

Once the placeholders of the template (e.g., 228) have been populated with the identifiers, the processable query instance (e.g., 236) may be generated. The processable query template (e.g., 236) may include (i) a query template (e.g., a schema for outlining a pre-defined structure of a query with placeholders for identifiers of the query), (ii) identifiers (e.g., values and/or data, based on explicitly defined relationships from a database schema, that are set in the placeholders of the query template to generate the processable query), (iii) query metadata (e.g., query identification, timestamp, user credentials, permission levels, etc.), etc. The processable query instance (e.g., 236) may be serviceable by a query servicing engine.

After the processable query instance (e.g., 236) has been generated, a database servicing process (e.g., 238) may be performed. During the database servicing process (e.g., 238), the processable query instance (e.g., 236) may be ingested by the query servicing engine. The query servicing engine may include (i) database management systems (e.g., MySQL, PostgreSQL, Oracle Database, etc.), (ii) distributed database systems (e.g., Amazon Aurora, Google Cloud Spanner, Apache Cassandra, etc.), (iii) query engines (e.g., Apache Hive, Presto, Amazon Athena, etc.), etc.

To service the data operation request (e.g., 230), the query servicing engine may perform, based on processing of the processable query instance (e.g., 236), the at least one operation on the at least the portion of the data in a data repository (e.g., 240). The at least one operation may include filtering, joining, aggregating, grouping, updating, deleting, transforming, sorting, constraining, etc. on the at least the portion of the data.

The data repository (e.g., 240) may include stored data such as (i) structured data (e.g., tables with rows and/or columns), (ii) unstructured data (e.g., text documents), (iv) semi-structured data (e.g., data with tags and/or metadata), (v) system logs (e.g., first records of system activities), (vi) audit trails (e.g., second records of user activities), and/or (vi) any other stored data. The query servicing engine may perform the at least one operation using the data (e.g., 242) of the data repository (e.g., 240).

After servicing the data operation request (e.g., 230), the query servicing engine may obtain and/or generate the data (e.g., 242). The data (e.g., 242) may include (i) transformed data (e.g., original data of the data repository (e.g., 240) can be (a) filtered, (b) aggregated, (c) computed, and/or (d) modified through any other operation to generate the transformed data), (ii) summarized data (e.g., (a) an average, (b) a count, (c) a sum, and/or (d) any other statistical measure) can be generated using the original data of the data repository (e.g., 240)), (iii) extracted data (e.g., a subset of the original data of the data repository (e.g., 240) may be extracted that meets a criteria specified by the processable query instance (e.g., 236)), (iv) combined data (e.g., the original data of the data repository (e.g., 240) can be combined to generate the combined data), (v) confirmation data (e.g., (a) status messages, (b) status metadata (e.g., (1) a number of records affected, (2) time taken to complete the at least one operation, and/or (3) any other information about the data (e.g., 242) and/or the at least one operation), (c) validation checks (e.g., any information on an integrity and/or accuracy of performance of the at least one operation), (d) audit logs (e.g., records of the at least one operation for tracking and/or accounting purposes), and/or (e) any other information that provides confirmation of the servicing, by the query servicing engine, the data operation request (e.g., 230).

Thus, via the third data flow diagram illustrated in FIG. 2C, a system in accordance with an embodiment may process a processable query instance (e.g., 236). Consequently, the distributed system may be more likely to be able to provide desired computer implemented services by using the refined dependency graph (e.g., 234) to generate the processable query instance (e.g., 236). The processable query instance (e.g., 236) may be processed by the query servicing engine to service the data operation request (e.g., 230).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage use of data sources of a distributed system. FIG. 3 illustrates a method that may be performed by the components of the distributed system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the use of the data sources of the distributed system in accordance with an embodiment is shown. The method may be performed, for example, by any of the components of the system of FIG. 1, and/or other components not shown therein.

At operation 300, a data operation request may be obtained. The data operation request may be obtained by (i) transmitting, by a user, an application, and/or any other entity, the data operation request through (a) a front-end interface, (b) an application user interface (API) and/or (b) any other interface, (ii) generating, by an automated system, the data operation request, (iii) managing, by a workflow engine, the data operation request in a data pipeline, and/or (iv) any other method to obtain the data operation request. The data operation request may include a request to perform at least one operation on at least a portion of data in a data repository of the distributed system. The at least one operation may include filtering, joining, aggregating, grouping, updating, deleting, transforming, sorting, constraining, etc. on the at least the portion of the data.

At operation 302, a template based on the data operation request may be identified. The template based on the data operation request may be identified by may be identified by (i) performing a structure analysis, by the distributed system, of the data processing request and/or (ii) matching the template to the data operation request. The structure analysis may include (i) identifying the at least one operation requested by the data operation request and/or (ii) identifying components of the data operation request including (a) data object names, (b) column names, (c) value types, (d) conditions, (e) join requirements, and/or (f) any other components. The template may be matched by (i) performing a search for the template that includes (a) the at least one operation and/or (b) the components of the data operation request.

At operation 304, the template may be populated using a refined dependency graph to obtain a processable query, the refined dependency graph comprising: a plurality of nodes based on data objects in the data sources, a first plurality of edges between the nodes, the first plurality of the edges being based on explicitly defined relationships between the data objects, and/or a second plurality of the edges between the nodes, the second plurality of the edges being based on inferred relationships between the data objects.

The template may be populated (i) filtering the data objects, based on the data operation request, the first plurality of the edges and the second plurality of the edges, to identify at least one of the data objects and/or (ii) adding at least one identifier for the at least one of the data objects to the template to generate the processable query.

The data objects may be filtered by traversing at least one edge of the first plurality of the edges and/or the second plurality of the edges, starting from one node of the nodes to a second node connected by the at least one edge. As a result, a first explicitly defined relationship and/or a first inferred relationship may be established between the first node (and therefore a first data object) and/or the second node (and therefore a second data object). The template may be populated by setting identifiers (e.g., column names, keys, indices, any other identifier of a data object) from the first data object and/or the second data object in placeholders of the template to generate the processable query.

At operation 306, the processable query may be processed using a query servicing entity to service the data operation request. The processable query may be processed by (i) ingesting, by the query servicing engine, the processable query, (ii) obtaining, by the query servicing engine and based on the processable query, retrieved data from at least one database on at least one data processing system of the distributed system, and/or (iii) performing the at least one operation requested by the data operation request using the retrieved data.

The method may end following operation 306.

Thus, via the method shown in FIG. 3, embodiments herein may likely improve a likelihood of managing the use of the data sources of the distributed system. By improving the likelihood of managing the use of the data sources of the distributed system, the distributed system may be more likely to provide desirable computer implemented services by, for example, obtaining inferred relationships between data objects, improving an efficiency of the at least one operation performed by the query servicing engine, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing use of data sources of a distributed system, the method comprising:
obtaining a data operation request;
identifying a template based on the data operation request;
generating a refined dependency graph for the data sources by at least:
extracting database schemas from databases of the data sources, each of the data sources being a computing device, the database schemas comprise data objects stored in the databases, and each of the data objects being a data structure that stores data;
extracting all of the data objects from the data schemas; and
generating inferred relationships between the data objects, the inferred relationships supplement explicitly defined relationships between the data objects that are already defined in the database schemas;
populating the template using the refined dependency graph to obtain a processable query, the refined dependency graph comprising:
a plurality of nodes based on the data objects
a first plurality of edges between the nodes, the first plurality of the edges being based on the explicitly defined relationships between the data objects, the first plurality of the edges having different edge types based on a similarity level between the nodes connected by the first plurality of edges, and
a second plurality of the edges between the nodes, the second plurality of the edges being based on the inferred relationships between the data objects; and
processing the processable query using a query servicing entity to provide one or more computer implemented services to complete the data operation request, a first level of accuracy of the one or more computer implemented services provided to complete the data operation request using both the inferred relationships and the explicitly defined relationships being higher than a second level of accuracy associated with using only the explicitly defined relationships without the generating of the refined dependency graph to generate the inferred relationships.

2. The method of claim 1, wherein the data operation request comprises a database request.

3. (canceled)

4. The method of claim 1, wherein the inferred relationships are based on relationships between the data objects, the relationships between the data objects being based on embeddings derived from the data objects and machine learning model analysis.

5. The method of claim 4, wherein the relationships between the data objects are based on semantic similarities between the embeddings.

6. The method of claim 5, wherein the inferred relationships are based, at least in part, on semantic similarities between the embeddings.

7. The method of claim 1, wherein the template is not processable by a query servicing engine due to presence of unpopulated placeholders in the template.

8. The method of claim 1, wherein populating the template using the refined dependency graph to obtain the processable query comprises:
filtering the data objects, based on the data operation request, the first plurality of the edges and the second plurality of the edges, to identify at least one of the data objects; and
adding at least one identifier for the at least one of the data objects to the template to generate the processable query.

9. A non-transitory machine-readable medium having instructions stored therein, which when executed by a processor, cause the processor to perform operations for managing use of data sources of a distributed system, the operations comprising:
obtaining a data operation request;
identifying a template based on the data operation request;
generating a refined dependency graph for the data sources by at least:
extracting database schemas from databases of the data sources, each of the data sources being a computing device, the database schemas comprise data objects stored in the databases, and each of the data objects being a data structure that stores data;
extracting all of the data objects from the data schemas; and
generating inferred relationships between the data objects, the inferred relationships supplement explicitly defined relationships between the data objects that are already defined in the database schemas;
populating the template using the refined dependency graph to obtain a processable query, the refined dependency graph comprising:
a plurality of nodes based on the data objects,
a first plurality of edges between the nodes, the first plurality of the edges being based on the explicitly defined relationships between the data objects, the first plurality of the edges having different edge types based on a similarity level between the nodes connected by the first plurality of edges, and
a second plurality of the edges between the nodes, the second plurality of the edges being based on the inferred relationships between the data objects; and
processing the processable query using a query servicing entity to provide one or more computer implemented services to complete the data operation request, a first level of accuracy of the one or more computer implemented services provided to complete the data operation request using both the inferred relationships and the explicitly defined relationships being higher than a second level of accuracy associated with using only the explicitly defined relationships without the generating of the refined dependency graph to generate the inferred relationships.

10. The non-transitory machine-readable medium of claim 9, wherein the data operation request comprises a database request.

11. (canceled)

12. The non-transitory machine-readable medium of claim 9, wherein the inferred relationships are based on relationships between the data objects, the relationships between the data objects being based on embeddings derived from the data objects and machine learning model analysis.

13. The non-transitory machine-readable medium of claim 12, wherein the relationships between the data objects are based on semantic similarities between the embeddings.

14. The non-transitory machine-readable medium of claim 13, wherein the inferred relationships are based, at least in part, on semantic similarities between the embeddings.

15. A data processing system, comprising:
a processor; and
a memory coupled to the processor to store instructions, which when executed by the processor, cause the processor to perform operations managing use of data sources of a distributed system, the operations comprising:
obtaining a data operation request;
identifying a template based on the data operation request;
generating a refined dependency graph for the data sources by at least:
extracting database schemas from databases of the data sources, each of the data sources being a computing device, the database schemas comprise data objects stored in the databases, and each of the data objects being a data structure that stores data;
extracting all of the data objects from the data schemas; and
generating inferred relationships between the data objects, the inferred relationships supplement explicitly defined relationships between the data objects that are already defined in the database schemas;
populating the template using the refined dependency graph to obtain a processable query, the refined dependency graph comprising:
a plurality of nodes based on the data objects,
a first plurality of edges between the nodes, the first plurality of the edges being based on the explicitly defined relationships between the data objects, the first plurality of the edges having different edge types based on a similarity level between the nodes connected by the first plurality of edges, and
a second plurality of the edges between the nodes, the second plurality of the edges being based on the inferred relationships between the data objects; and
processing the processable query using a query servicing entity to provide one or more computer implemented services to complete the data operation request, a first level of accuracy of the one or more computer implemented services provided to complete the data operation request using both the inferred relationships and the explicitly defined relationships being higher than a second level of accuracy associated with using only the explicitly defined relationships without the generating of the refined dependency graph to generate the inferred relationships.

16. The data processing system of claim 15, wherein the data operation request comprises a database request.

17. (canceled)

18. The data processing system of claim 15, wherein the inferred relationships are based on relationships between the data objects, the relationships between the data objects being based on embeddings derived from the data objects and machine learning model analysis.

19. The data processing system of claim 18, wherein the relationships between the data objects are based on semantic similarities between the embeddings.

20. The data processing system of claim 19, wherein the inferred relationships are based, at least in part, on semantic similarities between the embeddings.

21. The method of claim 1, wherein the edge types comprise a hierarchy to indicate the similarity level between the nodes connected by the first plurality of edges.

22. The method of claim 21, wherein generating the refined dependency graph for the data sources further comprises, while generating the inferred relationships between the data objects, deleting one of the first plurality of edges between two nodes of the nodes, wherein the similarity level between the two nodes being determined to be lower than a predetermined similarity threshold.

23. The method of claim 21, wherein generating the refined dependency graph for the data sources further comprises, while generating the inferred relationships between the data objects, keeping, instead of deleting, one of the first plurality of edges between two nodes of the nodes, wherein the similarity level between the two nodes being determined to be lower than a predetermined similarity threshold, and the one of the first plurality of edges being kept to allow for a future change to the data objects that would cause the similarity level between the two nodes to exceed the predetermined similarity threshold.
